(19) United States
(12) Patent Application Publication
(10) Pub. No.: US 2003/0084562 A1
(43) Pub. Date: May 8, 2003

(54) Manufacturing method for electroacoustic transducer

(75) Inventors: Mitsuhiro Masuda, Shizuoka (JP); Yoshiharu Oishi, Shizuoka (JP); Harunobu Tsuchiya, Shizuoka (JP)

Correspondence Address: SUGHRUE MION, PLLC, 2100 PENNSYLVANIA AVENUE, N.W., WASHINGTON, DC, 20037, US

(73) Assignee: STAR MICRONICS CO., LTD.

(21) Appl. No.: 10/282,135

(22) Filed: Oct. 29, 2002

(30) Foreign Application Priority Data
Nov. 5, 2001 (JP) P.2001-339936

(51) Int. Cl. H04R 31/00; H01F 7/06

(52) U.S. Cl. 29/594; 29/607

(57) ABSTRACT

A base is integrally formed with a synthetic resin case by insert molding. A fixing portion of a core is engaged with a fixing hole of the base. An assembly jig is used to press the fixing portion to caulk the core to the base. The distance between a free end of the core and a diaphragm supporting portion of the case is guraranteed at a desired value.

### BACKGROUND OF THE INVENTION

1. Field of the Invention

The present invention relates to a manufacturing method for an electroacoustic transducer which is used for a mobile phone, etc.

2. Description of the Related Art

FIG. 4 is a sectional view of an electroacoustic transducer 1 of prior art. FIG. 5 is a bottom view of the electroacoustic transducer 1 of FIG. 4. A core 2 comprises a core body 3 and a fixing portion 4 continued from the core body 3. The fixing portion 4 is caulked to a base 5 made of ferromagnetic material. The fixing portion 4 and the base 5 is integrally formed with a synthetic resin case 6 by insert molding. A diaphragm 8 is mounted on a diaphragm supporting portion 7 of the case 6. A cover 9 is laid over the case 6 to be fixed thereto. A coil 11 is wound on the core body 3 of the core 2. An annular magnet 12 is fixed to the base 5.

FIG. 6 shows part of a conventional manufacturing method for the electroacoustic transducer 1. First, as shown in FIG. 6(1), the core 2 is prepared, comprising the core body 3 and the fixing portion 4 integrally formed therewith.

Second, as shown in FIG. 6(2), a jig is prepared, having a recess 14 where the core body 3 is fitted. The fixing portion 4 of the core 2 is passed through a caulking hole 16 of the base 5 to be projected upward in the FIG. 6(2). The projected part of the fixing portion 4 is pressed into an end part 17 which is radially extended on the base 5. The fixing portion 4 is thereby fixed to the base 5 by caulking.

Then, as shown in FIG. 6(3), the base 5 having the core 2 fixed thereto is fixed to the case 6 by insert molding.

As in the prior art, however, a variation in injection molding pressure would possibly cause a variation in the distance g3 in the axial direction of the core 2 (vertical direction in FIGS. 4 and 6(3)) between a free end 21 of the core 2 facing the diaphragm 8 and the diaphragm supporting portion 7 of the case 6 where the diaphragm 8 abuts. This would cause a variation in resonance frequency, resulting in a variation in sound characteristics for every product.

### SUMMARY OF THE INVENTION

An object of the present invention is to provide a manufacturing method for an electroacoustic transducer which prevents a variation in sound characteristics.

The present invention relates to a manufacturing method for an electroacoustic transducer comprising a case, a base fixed to the case, the base having a core fixed thereon, the core having a fixing portion and a free end at opposite ends, and a diaphragm supported on a diaphragm supporting portion of the case, comprising:

forming the case with the base fixed thereto by insert molding;

engaging the fixing portion with a hole formed in the base; and

deforming the fixing portion to fix the core to the base while maintaining the distance in the axial direction of the core between the free end and the diaphragm supporting portion at a certain value.

According to the invention, the base is integrally formed with the case by insert molding, and then the core is fixed to the fixing hole of the base by deformation of the fixing portion of the core. This structure prevents a variation in the distance between the free end of the core and the diaphragm supporting portion of the case. It therefore prevents a variation in resonance frequency for every product, improving the product quality.

Further, the manufacturing method of the invention is easily implemented by use of an assembling jig of a simple structure. The assembling jig comprises a groove where the diaphragm supporting portion is engaged and a core supporting surface formed in an area surrounded by the groove. An end of the diaphragm supporting portion abuts the bottom of the groove and the free end of the core abuts the core supporting surface.

### BRIEF DESCRIPTION OF THE DRAWINGS

FIG. 1 is a sectional view of an electroacoustic transducer of an embodiment of the present invention.

FIG. 2 is a bottom view of the electroacoustic transducer in FIG. 1.

FIG. 3 shows part of a manufacturing process for the electroacoustic transducer in FIGS. 1 and 2.

FIG. 4 is a sectional view of the electroacoustic transducer of prior art.

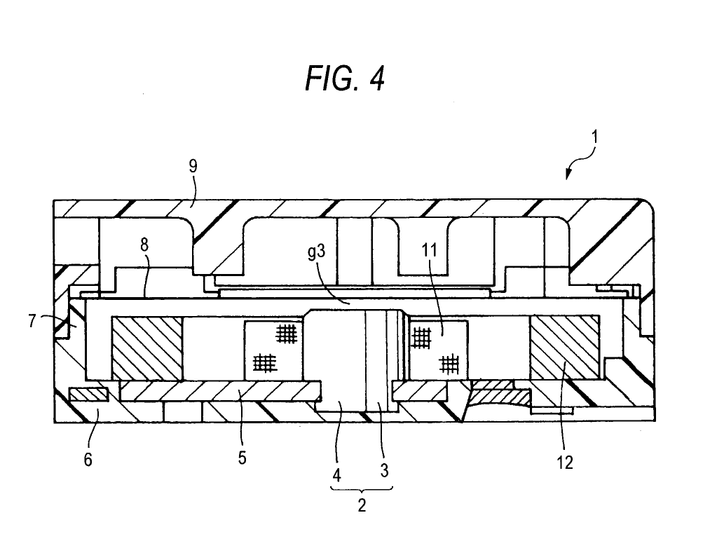

FIG. 5 is a bottom view of the electroacoustic transducer in FIG. 4.

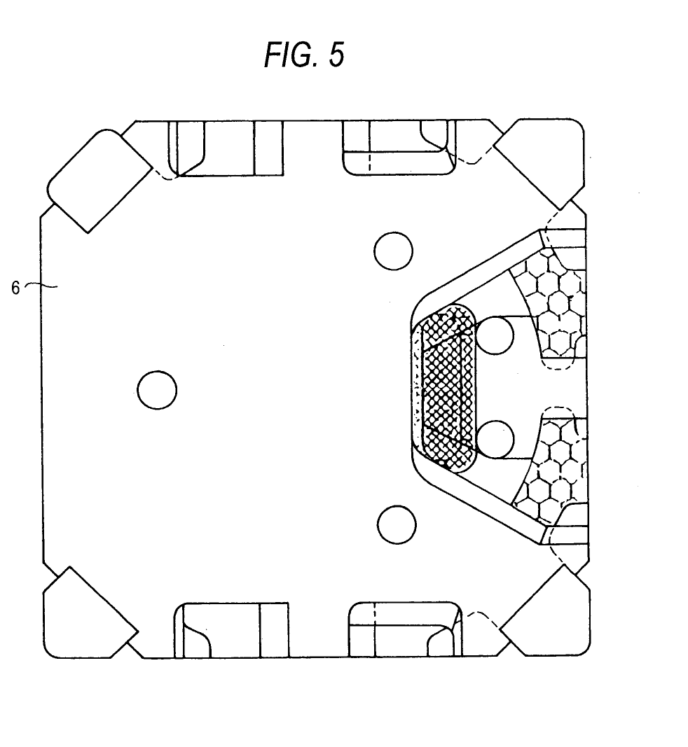

FIG. 6 shows part of a manufacturing process for the electroacoustic transducer in FIGS. 4 and 5.

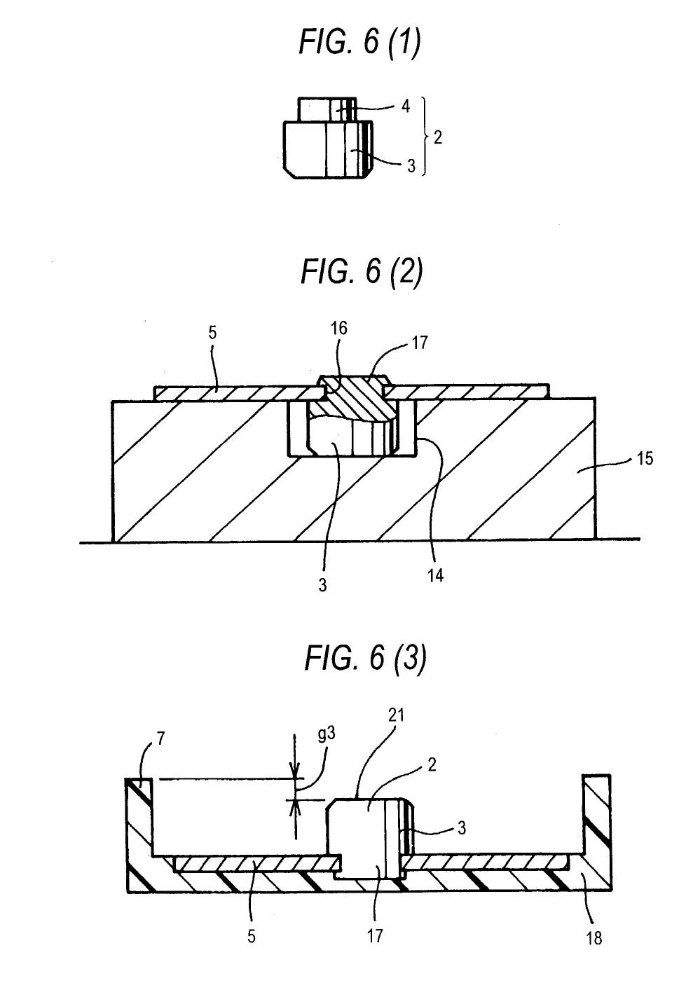

### DETAILED DESCRIPTION OF THE INVENTION

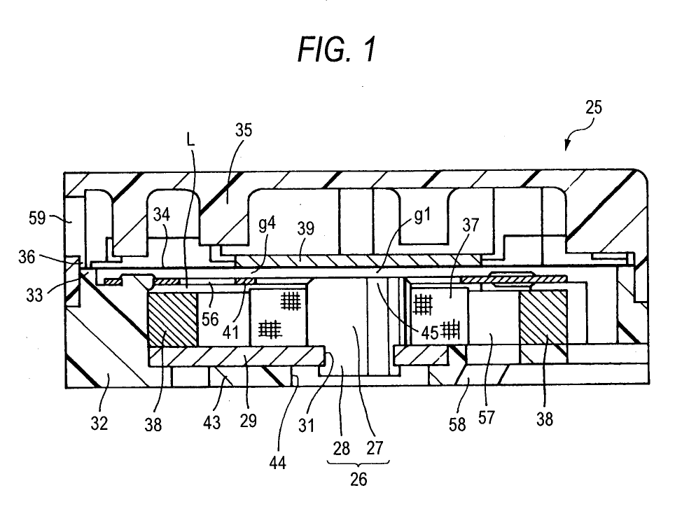

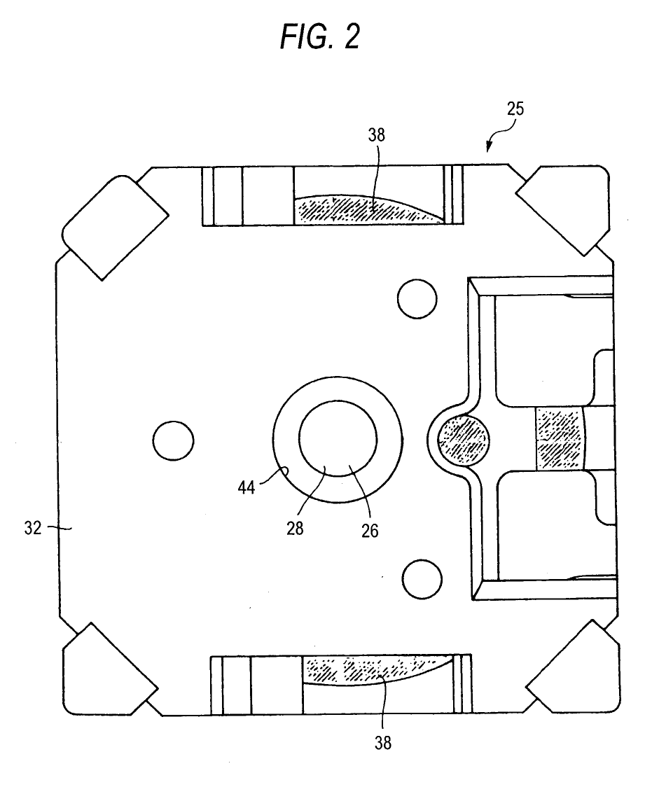

FIG. 1 is a sectional view of an electroacoustic transducer 25 and FIG. 2 is a bottom view thereof. The electroacoustic transducer 25 is, for example, used in a mobile phone. A core 26 comprises a cylindrical core body 27 and a fixing portion 28 of a smaller diameter than the core body. The core 26 is, for example, made of ferromagnetic material such as steel. The fixing portion 28 is fixed to a disc base 29 by caulking at a fixing hole 31. The base 29 is fixed to a case 32 by insert molding. The case is made of thermoplastic resin such as LCP resin, having a diaphragm supporting portion 33 where a diaphragm is mounted in circumference. A cover 35 made of synthetic resin is laid over the case 32 to be fixed thereto.

A coil 37 is wound on the core body 27 on the base 29. An annular magnet 38 is fixed on the base 29 so as to surround the coil 37.

A mass 39 made of ferromagnetic material is fixed on the diaphragm 34 on the far side of the core 26 (upper side in FIG. 1). A magnetic flux guide member 41 made of ferromagnetic material is fixed to the case 32 in circumference. The magnetic flux guide member 41 is rigid and disk-shaped, extending radially inward from just above the magnet 38 toward just below the periphery of the mass 39 with a gap vertically reserved therebetween. A magnetic path is thereby formed through the magnet 38, the magnetic flux guide member 41, the mass 39, the core 26, and the base 29 to drive the diaphragm 34 by intense electromagnetic force. The diaphragm 34 and the magnetic flux guide member 41 are, in circumference, commonly supported and fixed on the case 32, successfully maintaining the distance g4 between the diaphragm 34 and the magnetic flux guide member 41 to a certain value. Further, a gap L for the passage of air is provided between the top of the magnet 38 and the bottom of the magnetic flux guide member 41, and an air hole 56 is formed in the magnetic flux guide member 41. This structure improves air flow without modifying the magnet 38 in shape so that an abnormal operation of the diaphragm 34 is prevented. A space 57 surrounded by the magnet 38 is communicated with air via a communicating hole 58 formed in the case 32. A front space of the diaphragm 34 surrounded by the cover 35 is communicated with air via a communicating hole 59.

An air hole 44 is formed in the case 32 at the bottom 43, facing the fixing portion 28 of the core 26 and part of the base 29 adjacent to the fixing portion 28. The predetermined distance g1 is reserved when the coil 37 is not energized between a free end 45 of the core body 27 and the back surface of the diaphragm 34.

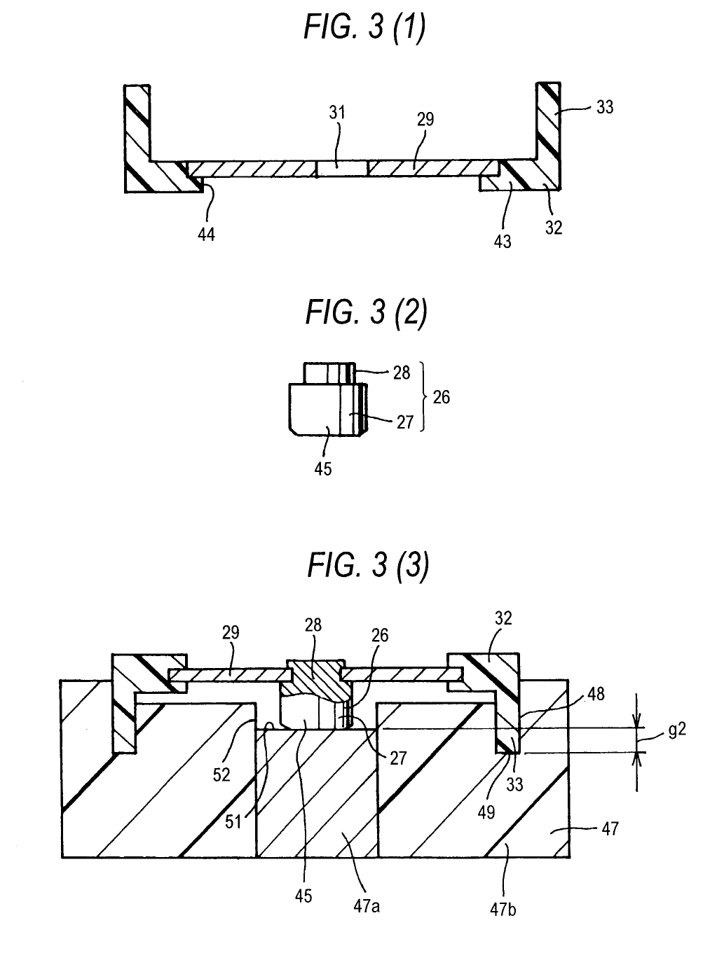

FIG. 3 shows a manufacturing process of the electroacoustic transducer 25 of an embodiment of the present invention shown in FIGS. 1 and 2. First, as shown in FIG. 3(1), the base 29 is integrally fixed to the case 32 by insert molding.

Second, as shown in FIG. 3(2), the core 26 is prepared, which comprises the core body 27 and the fixing portion continued from the core body 27. Then, as shown in FIG. 3(3), an assembling jig 47 is prepared for caulking. The assembling jig 47 comprises a base part 47a made of, for example, metal material and a peripheral part 47b made of synthetic resin. The peripheral part 47b has a groove 48 where the diaphragm supporting portion 33 of the case 32 is engaged. The end of the diaphragm supporting portion 33 abuts a bottom 49 of the groove 48. A core supporting surface 51 is provided in the base part 47a in an area surrounded by the groove 48. The core supporting surface 51 corresponds to a bottom of a recess 52 opened upward.

The fixing portion 28 of the core 26 shown in FIG. 3(2) is engaged with the fixing hole 31 of the base 29 shown in FIG. 3(1), and the case 32 is set on the assembling jig 47. The projected part of the fixing portion 28 from the hole 31 is pressed by, for example, a pressing machine and the core 26 is thereby fixed to the base 29 by caulking. Deformation of the base 29 caused by the caulking process makes the free end 45 of the core body 27 abut the core supporting surface 51 and also makes the diaphragm supporting portion 33 abut the bottom 49 of the groove 48. Therefore, the distance g2 in the axial direction of the core 26 (vertical direction in FIG. 3(3)) from the free end 45 to the diaphragm supporting portion 33 is guaranteed to equal to the distance g1. A variation in the distance g2 for every product is thereby prevented. The core supporting surface 51 of the assembling jig 47 may be made of metal material such as alloy tool steel while the other part of the assembling jig 47 may be made of synthetic resin such as polyacetal resin, ABS resin, or other thermoplastic or thermosetting resin. If the core supporting surface is made of metal material, a strict control of the distance g2 is easily achieved.

Though the core 26 is fixed to the base 29 by caulking in this embodiment, the invention is not limited to the described method. For example, the fixing portion 28 of the core 26 may be fixed to the base 29 by laser welding. Since laser welding reduces the burden on the core 26 and the base 29 than caulking, a more strict control of the distance g2 is easily achieved.

According to the invention, the base is integrally formed with the synthetic resin case by insert molding, and then the core is fixed to the fixing hole of the base by deformation of the fixing portion of the core. This structure prevents a variation in the distance g2 between the free end of the core and the diaphragm supporting portion of the case. It therefore prevents a variation in resonance frequency for every product, improving the product quality. Further, the manufacturing method of the invention is easily implemented by the assembling jig having the groove where the diaphragm supporting portion is engaged and the core supporting surface formed in the area surrounded by the groove.

What is claimed is:

1. A manufacturing method of an electroacoustic transducer comprising a case, a base fixed to the case, the base having a core fixed thereon, the core having a fixing portion and a free end at opposite ends, and a diaphragm supported on a diaphragm supporting portion of the case, comprising:
forming the case with the base fixed thereto by insert molding;
engaging the fixing portion with a hole formed in the base; and
deforming the fixing portion to fix the core to the base while maintaining the distance in the axial direction of the core between the free end and the diaphragm supporting portion at a certain value.

2. The manufacturing method as claimed in claim 1, wherein deforming the fixing portion to fix the core to the base is carried out by an assembling jig, the assembling jig comprises a groove where the diaphragm supporting portion is engaged and a core supporting surface formed in an area surrounded by the groove, and an end of the diaphragm supporting portion abuts the bottom of the groove and the free end of the core abuts the core supporting surface.
